(19) United States
(12) Patent Application Publication
(10) Pub. No.: US 2009/0213734 A1
(43) Pub. Date: Aug. 27, 2009

(54) PACKET TRANSMISSION DEVICE

(75) Inventors: Kenji HASHINAGA, Fukuoka (JP); Masamichi Kasa, Fukuoka (JP); Katsuhiko Hirashima, Fukuoka (JP); Michihiko Goto, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/354,148

(22) Filed: Jan. 15, 2009

(30) Foreign Application Priority Data
Feb. 22, 2008 (JP) 2008-041848

(51) Int. Cl. H04L 12/24

(52) U.S. Cl. 370/235

(57) ABSTRACT

A packet transmission device including plural queues for storing packets to be transmitted is provided. The device includes a token storage section for storing queue information for identifying a queue and an accumulated token value in which token values assigned to the queue are accumulated so as to obtain correspondence therebetween and a capture section for identifying one or both of an unused queue and a queue in which the accumulated token value exceeds a given upper limit value and capturing the queue information thereof. The device includes a selection section for selecting the queue information of the unidentified queue on the basis of the queue information captured using the capture section and an addition section for adding the accumulated token value of the token storage section on the basis of the queue information selected using the selection section.

### CROSS-REFERENCE TO RELATED APPLICATIONS

This application is related to and claims priority to Japanese Patent Application No. 2008-41848, filed on Feb. 22, 2008, and incorporated herein by reference.

### BACKGROUND

1. Field

The embodiments discussed herein are directed to a packet transmission device.

2. Description of the Related Art

Conventionally, in a packet transmission device, control that may use a token as a code for judging whether packet output is permitted has been used as a method for controlling (smoothing) the output rate of packets output from the packet transmission device.

A general control method that may use a token a token control circuit that may use a token periodically assigns and adds a token value to each of plural queues in which a packet output from a packet transmission device is stored. Furthermore, the token control circuit outputs the packet in the case that the token value, i.e., the value of the token, assigned to the queue is larger than the packet length of the packet to be output. Moreover, the token control circuit subtracts the value corresponding to the packet length of the output packet from the token value of the queue in which the output packet is stored.

Various methods have been used to try to smooth the output rate. For example, in a packet transmission device, as illustrated in FIG. 1A, processing for adding a token value is repeated for each queue. Hence, a token addition cycle indicating the time period until the token is added again to the same queue increases as the number of queues controlled and processed using one token control circuit. Hence, a method is used in which an addition token value that is added at one time is increased so as to correspond to the token addition cycle that increases as the number of queues is increased.

Another method used is where the number of token control circuits disposed inside a single packet transmission device is increased as the number of queues is increased. As illustrated in FIG. 1B, the packet transmission device includes token control circuits and token storage memory, the number of each of which is the same as the number of the queues used in the packet transmission device, and each token control circuit carries out only the token control for one queue under the charge of the token control circuit.

### SUMMARY

It is an aspect of the embodiments discussed herein to provide a packet transmission device that includes plural queues for storing packets to be transmitted; a token storage section for storing queue information for identifying a queue and an accumulated token value in which token values assigned to the queue are accumulated, so as to obtain correspondence therebetween; a capture section for identifying one or both of an unused queue and a queue in which the accumulated token value exceeds a given upper limit value and capturing the queue information thereof a selection section for selecting the queue information of the unidentified queue on the basis of the queue information captured using the capture section; an addition section for adding the accumulated token value of the token storage section on the basis of the queue information selected using the selection section; a token control section for comparing the packet length of the packet stored in a queue with the accumulated token value corresponding to the queue and judging whether the output of the packet is possible; and a packet output control section for outputting the packet from the queue and subtracting the packet length from the accumulated token value in the case that the token control section has judged that the packet output is possible.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIGS. 1A and 1B illustrate a conventional method;

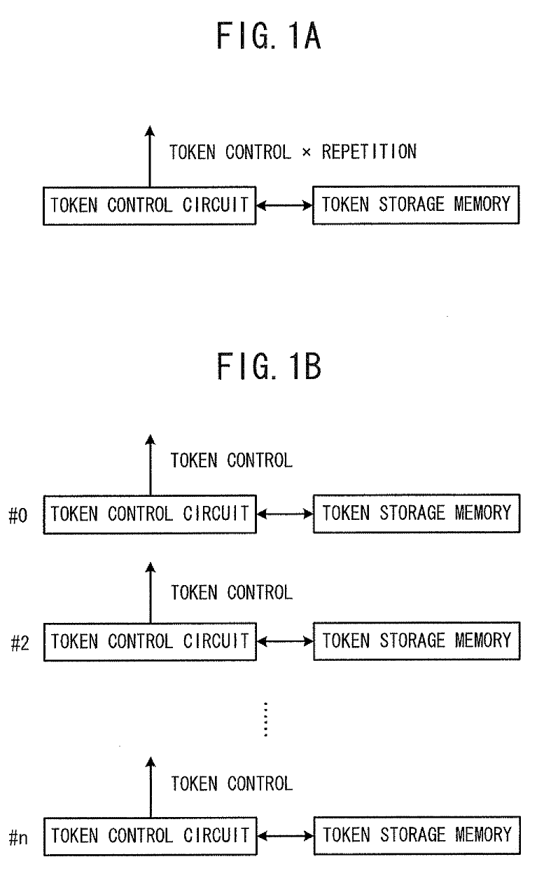

FIG. 2A illustrates an exemplary embodiment;

FIG. 2B illustrates an exemplary embodiment;

FIG. 3 illustrates a packet transmission device according to an exemplary embodiment;

FIG. 4 illustrates a packet transmission device according to an exemplary embodiment;

FIG. 5 illustrates a token storage memory according to an exemplary embodiment;

FIG. 6 illustrates an addition target information storage section according to an exemplary embodiment;

FIG. 7 illustrates a token value addition processing section according to an exemplary embodiment;

FIG. 8 illustrates an addition ratio calculation section according to an exemplary embodiment;

FIG. 9 illustrates token value addition processing according to an exemplary embodiment;

FIG. 10 illustrates token value subtraction processing according to an exemplary embodiment;

FIG. 11 illustrates processing of an addition target control section according to an exemplary embodiment;

FIG. 12 illustrates the effect of the packet transmission device according to an exemplary embodiment;

FIG. 13 illustrates an effect of the packet transmission device according to an exemplary embodiment;

FIG. 14 illustrates effect of the packet transmission device according to an exemplary embodiment;

FIG. 15 illustrates a program programs of the packet transmission device according to an exemplary embodiment.

### DETAILED DESCRIPTION OF EMBODIMENTS

Conventionally, devices and methods, however, have had problems in effectively smoothing an output rate.

For example, conventionally, an addition token value to be added at one time is increased, the burst length indicating the amount of data (or the number of data) that may be output continuously is increased, and the packet transmission device cannot smooth the output rate meticulously. Furthermore, since the burst length is increased, packet overflow and packet discarding may occur in an opposite-side device that receives output packets.

For example, a case in which the shaping rate (output rate) is 1 Gbps. A relationship among the shaping rate, the addition token value and the token addition cycle is represented by the following Expression 1.

“Shaping rate”=“addition token value”/“token addition cycle” (Expression 1)

According to this Expression 1, for example, a packet transmission device that carries out the method in which an addition token value to be added at one time is increased, in the case that the token addition cycle is 1 μs, the addition token value is 125 bytes, and the burst length amounts to one packet of 100 bytes (one packet of 100 bytes is output continuously). Furthermore, in a similar way, in the case that the token addition cycle is 100 μs, the addition token value is 12500 bytes, and the burst length amounts to 125 packets of 100 bytes (125 packets of 100 bytes are output continuously, or 12 packets of 1000 bytes are output continuously).

As a result, as the token addition cycle increases from 1 μs to 100 μs, the burst length is increased from a value amounting to one packet of 100 bytes to a value amounting to 125 packets of 100 bytes.

Furthermore, conventionally a packet transmission device, a value larger than the addition token value is set as the upper limit value (the upper-limit accumulated token value, maximum burst value) of the token value that may be accumulated (so that the addition token values for several times may be accumulated). As a result, the conventional packet transmission device, which performs the method in which the addition token value to be added at one time is increased, outputs more packets than those corresponding to the burst length that is output depending on the addition token value to be added at one time.

As described above, conventionally a packet transmission device, which performs the method in which the addition token value to be added at one time is increased, cannot achieve meticulous control (a method in which a small addition token value is added at one time frequently). Hence, the burst length is increased, and the output rate cannot be smoothed properly.

Moreover, for example, conventionally a method that may use plural circuits, the packet transmission device cannot smooth the output rate properly without increasing the size of the circuit.

In comparison with a packet transmission device (assumed to be a packet transmission device A) includes N queues and one token control circuit, the conventional packet transmission device, which carries out the method in which plural circuits are used in the case that the token addition cycle is shortened to 1/N, must be includes a circuit size N times larger than that of the packet transmission device A. A method for effectively smoothing the output rate is not disclosed conventionally.

An exemplary embodiment provides a packet transmission device, a packet transmission method and a packet transmission program capable of effectively smoothing the output rate.

For the purpose of solving the above-mentioned problems and attaining the above-mentioned aspect, in the case that a given token value is added and assigned to each of plural queues in which a packet is stored and that an accumulated token value indicating the accumulation of the token values assigned to the queue is larger than the packet length of the packet stored in the queue, this packet transmission device outputs the packet from the queue; in the case that the packet is output from the queue, the packet transmission device subtracts the packet length from the accumulated token value of the queue from which the packet is output, the packet transmission device comprising a storage for storing queue information for identifying the queue and the accumulated token value of the queue so as to obtain correspondence therebetween; a capturing unit for capturing the queue information for identifying the queues not used in the packet transmission device and/or for capturing the queue information for identifying the queues in which the accumulated token values exceed a given upper limit value; a selector for selecting queues other than the queues selected from among the plural queues provided for the packet transmission device and identified by the captured queue information when the queue information is captured using the a capturing unit; and an adder for adding the given token value to only the accumulated token value stored in the a storage so as to correspond to the queue information for identifying the queues selected using the a selector when the given token value is added to the respective plural queues.

A packet transmission device includes a ratio calculator for calculating the ratio occupied by the queues selected from among the plural queues when the queues are selected using the a selector, wherein the an adder adds a token value corresponding to the ratio calculated using the ratio a calculator among the given token values to the queues selected using a selector.

The disclosed packet transmission device can properly smooth the output rate.

In addition, even when the token addition cycle is changed, the disclosed packet transmission device can change the addition token value depending on the change and can properly smooth the output rate.

Exemplary embodiments include a packet transmission device, a packet transmission method and a packet transmission program.

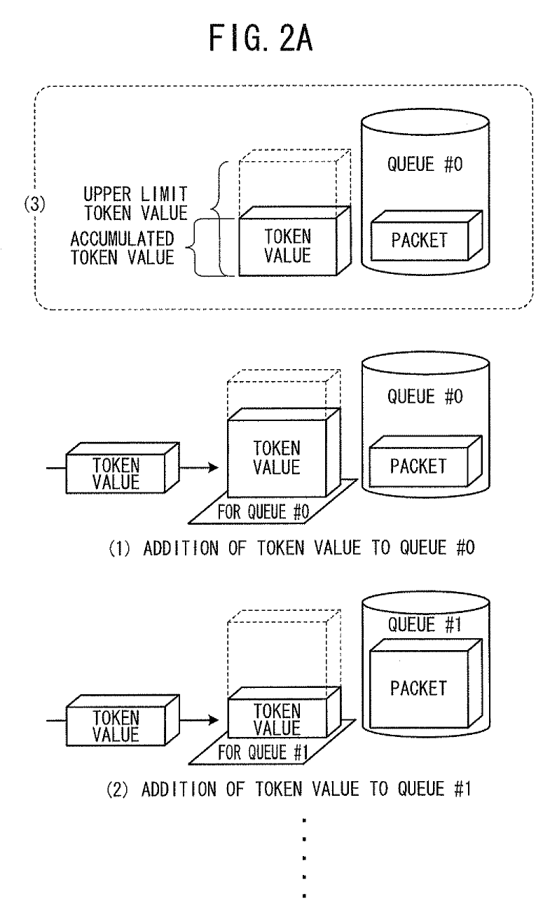

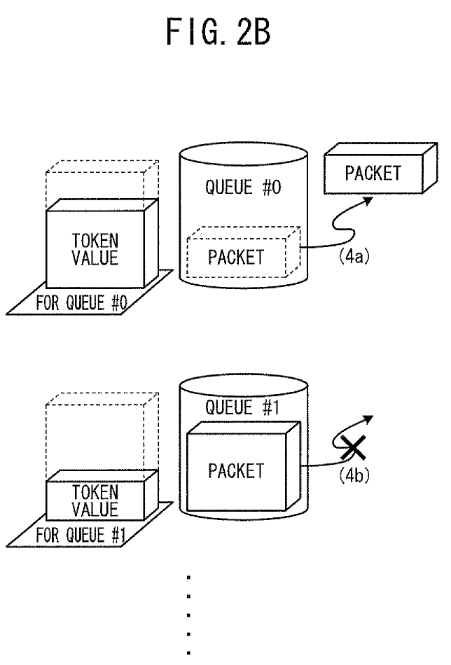

FIGS. 2A and 2B illustrate a token control.

The “packet transmission device” used in an exemplary embodiment controls the output of packets by performing control that may use tokens (token control). For example, the packet transmission device corresponds to a device includes a packet shaper function for controlling the output rate of packets.

Output rate control may be carried out using the token control in the packet transmission device is that it is necessary to impose a certain degree of restriction on network traffic when effectively using network resources (for example, network bandwidth) and assuring the service quality of network.

In this packet transmission device, input packets (packets to be output) are accumulated in a waiting line referred to as queue. Furthermore, generally, the packet transmission device has plural queues, and the output rate adjustment by the token control is performed in units of queues.

The token control carried out in the packet transmission device is described. As illustrated in FIG. 2A, a given token value is added and assigned every constant cycle to respective plural queues storing packets in the packet transmission device.

For example, a case in which the packet transmission device adds token values to 1024 queues (#0 to #1023, 1024 pieces in total) is taken as an example and explained. The packet transmission device performs processing for adding a token value to queue #0 as illustrated in FIG. 2A (1). After the processing for adding the token value to queue #0 is completed, processing for adding a token value to queue #1 is performed as illustrated in FIG. 2A (2). Then, the packet transmission device also adds sequentially token values to the other queues up to queue #1023 just as in the processing for adding token values to queue #0 and queue #1.

In the case that the token addition cycle indicating the time elapsed until a token value is added again to the same queue is 100 μs, the packet transmission device adds the token value to queue #0 again 100 μs after performing the processing for adding the token value to queue #0. In other words, the packet transmission device repeats the token value addition processing for the 1024 queues in a cycle of 100 μs.

The relationship among “token”, “token value” “addition token value”, “accumulated token value” and “upper limit token value” used in an exemplary embodiment is herein described briefly. “Token” represents a code (concept) for judging whether a packet is permitted to be output. “Token value” represents information being used as a token and includes information regarding an amount. “Addition token value” represents a token value that is added and assigned at one time to respective plural queues for storing packets using the packet transmission device.

Furthermore, as illustrated in FIG. 2A (3), “accumulated token value” is information indicating the total of the “token values” assigned to and accumulated at present in each queue, and “upper limit token value” is information indicating the upper limit value of the accumulated token value that is permitted to be assigned to each queue. “Accumulated token value” and “upper limit token value” are information given (or calculated or set) for each queue. In the case that a token value exceeding the upper limit token value is assigned, the packet transmission device discards this assigned value.

Moreover, in the case that the accumulated token value in a queue is larger than the packet length of the packet stored in the queue as illustrated in FIG. 2B, the packet transmission device outputs the packet from the queue. For example, in the example illustrated in FIG. 28 (4a), since the accumulated token value assigned to queue #0 is larger than the packet length of the packet to be output, the packet is output from queue #0 in the packet transmission device. As illustrated in FIG. 2B (4b), since the accumulated token value assigned to queue #1 is smaller than the packet length of the packet to be output, the packet is not output from queue #1 in the packet transmission device.

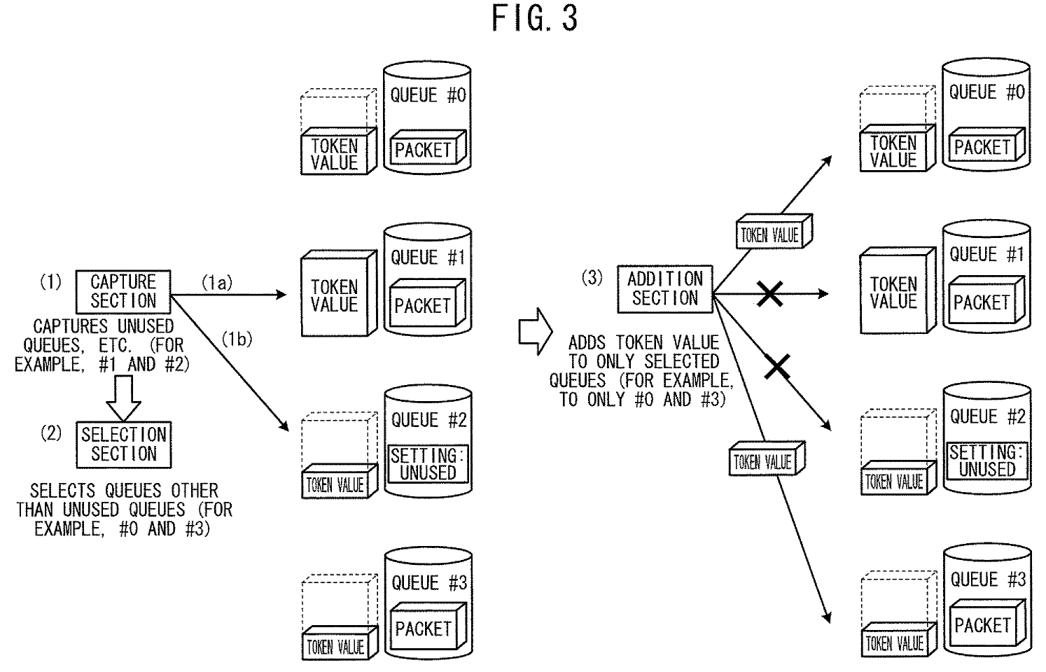

An exemplary embodiment FIG. 3 illustrates a packet transmission device according to an exemplary embodiment.

A packet transmission device according to an exemplary embodiment is a device for controlling the output of packets by performing token control and is mainly characterized by being capable of properly smoothing the output rate of packets. A case in which the packet transmission device includes four queues (queue #0, queue #1, queue #2 and queue #3) as illustrated in FIG. 3 is an example.

A packet transmission device according to an exemplary embodiment stores queue information for identifying a queue and the accumulated token value of the queue so as to obtain correspondence therebetween. The packet transmission device according to an exemplary embodiment stores each queue so as to obtain correspondence between the queue information and the accumulated token value.

Furthermore, as illustrated in FIG. 3(1), the packet transmission device according to an exemplary embodiment captures queue information for identifying unused queues and queue information for identifying queues, the accumulated token values of which exceed a given upper limit token value. For example, in the example illustrated in FIG. 3, in the packet transmission device according to an exemplary embodiment, the accumulated token value assigned to queue #1 exceeds the upper limit token value, and queue #2 is set as an unused queue. In this case, the capture section of the packet transmission device according to an exemplary embodiment captures queue information #1 for identifying queue #1 as a queue, the accumulated token value of which exceeds the upper limit token value as illustrated in FIG. 3 (1a) and captures queue information #2 for identifying queue #2 as an unused queue as illustrated in FIG. 3 (1b).

“An unused queue (corresponding to a queue not used in the packet transmission device set forth in the claims)” being used in an exemplary embodiment herein corresponds to, for example, a queue in which no packet is stored for a certain period (or a queue from which no packet is output for a certain period) or a queue having been set as “an unused queue” by a setter who uses the packet transmission device.

After capturing the queue information using the capture section, the packet transmission device according to an exemplary embodiment selects queues other than the queues identified by the captured information captured from among the plural queues provided for the packet transmission device. For example, the packet transmission device according to an exemplary embodiment includes queue #0, queue #1, queue #2 and queue #3. In this case, as illustrated in FIG. 3(2), the selection section of the packet transmission device according to an exemplary embodiment selects queue #0 and queue #3 other than queue #1 and queue #2 identified by the queue information captured using the capture section.

When adding a given token value to each of plural queues, the packet transmission device according to an exemplary embodiment adds the given token value to only the accumulated token values corresponding to the queue information for identifying the queues selected using the selection section. For example, as illustrated in FIG. 3(3), the packet transmission device according to an exemplary embodiment adds the given token value to only queue #0 and queue #3 selected using the selection section.

Hence, the packet transmission device according to an exemplary embodiment can properly smooth the output rate as the above-mentioned main characteristic.

For example, conventionally a method in which a token value is added to all the queues even when the number of queues is increased and an addition token value serving as a token value to be added at one time is increased at the time of the addition, the burst length is increased and the output rate cannot be smoothed properly. In comparison with this conventional method in which the addition token value to be added at one time is increased, the disclosed packet transmission device can shorten a token addition cycle by adding a token value to only the queues in which the addition is necessary. As a result, the output rate may be smoothed properly without increasing the addition token value to be added at one time.

Moreover, for example, even in the case that the addition token value is increased, in comparison with the conventional method (the token addition processing is performed for all the queues), the increased amount of the token value may be decreased, and the output rate may be smoothed properly.

For example, when the number of queues is increased, the number of token control circuits disposed inside a single packet transmission device is not increased. Hence, the token addition cycle may be shortened, and the output rate may be smoothed properly.

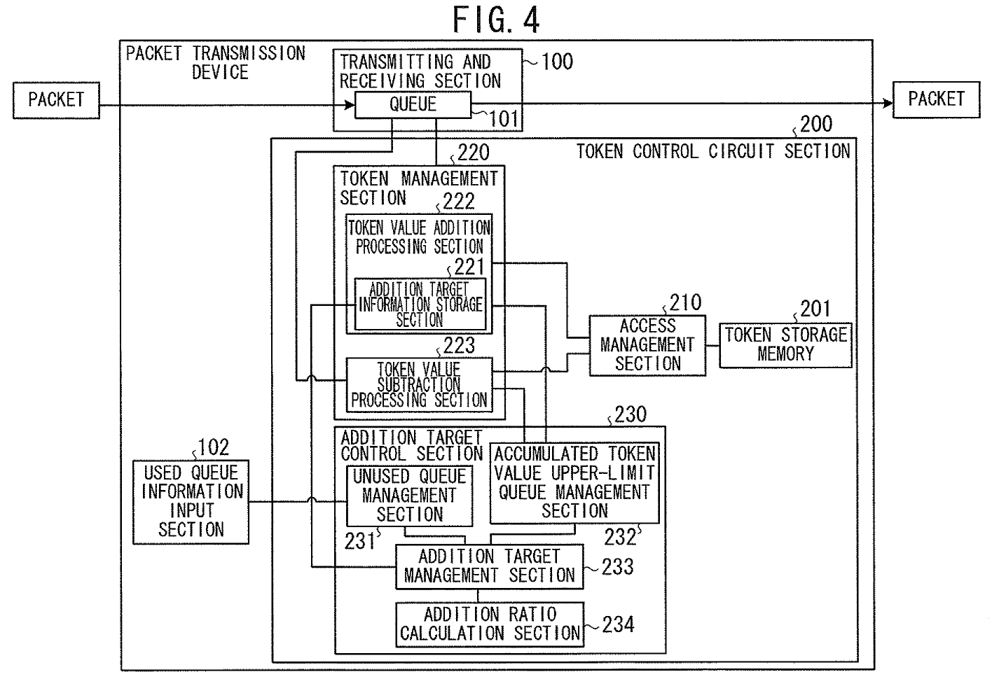

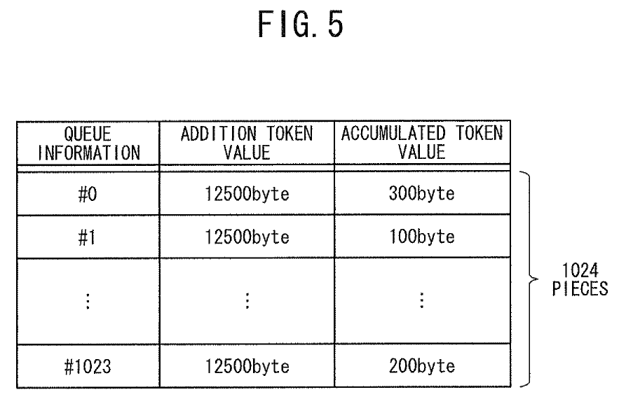

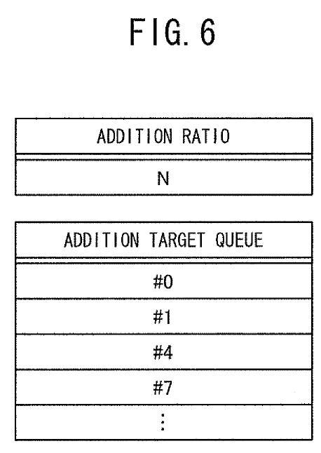

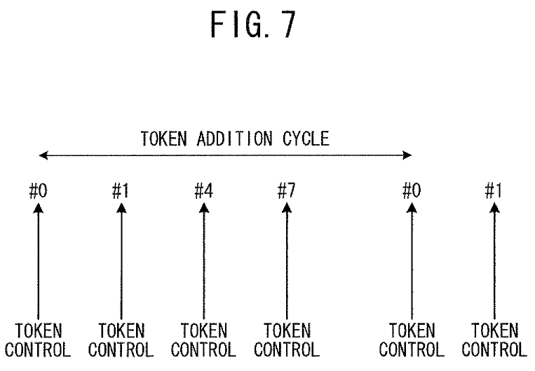

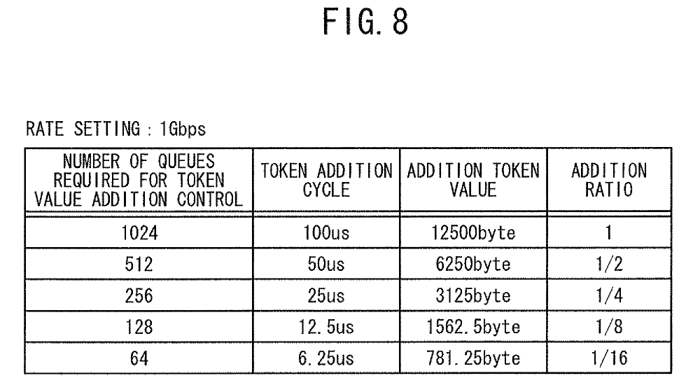

FIG. 4 illustrates a packet transmission device according to an exemplary embodiment. FIG. 5 illustrates a token storage memory according to an exemplary embodiment. FIG. 6 illustrates an addition target information storage section according to an exemplary embodiment. FIG. 7 illustrates a token value addition processing section according to an exemplary embodiment. FIG. 8 illustrates an addition ratio calculation section according to an exemplary embodiment.

As illustrated in FIG. 4, the packet transmission device includes a transmitting and receiving section 100, a used queue information input section 102 and a token control circuit section 200.

A case may include where an addition token value is set under the assumption that the packet transmission device includes 1024 queues 101 (#0 to #1023,1024 pieces in total), that the initial value of the token addition cycle is 100 μs, and that the token addition cycle is set at 100 μs by the user of the packet transmission device (in the case that the token addition cycle is 100 μs).

The transmitting and receiving section 100 includes queues 101 for temporarily storing packets and receives input of packets, stores the received packets in the queues 101 and outputs the packets stored in the queues 101. The transmitting and receiving section 100 outputs the packets stored in the queues 101 on the basis of the token control using a token management section 220 described later. Furthermore, the transmitting and receiving section 100 issues, to a token value subtraction processing section 223 described later, a notice to the effect that packets are output.

For example, when outputting the packet stored in the queue 101, the transmitting and receiving section 100 outputs the packet in the case that the output is permitted by the token control processing using the token management section 220 described later, and does not output the packet in the case that the output is not permitted by the token control processing using the token management section 220 described later.

In the transmitting and receiving section 100, in the case that the output is not permitted by the token control processing using the token management section 220 described later, for example, a token value is then added using a token value addition processing section 222 described later to the queue 101 in which the packet to be output is stored. When the output is then permitted by the token control processing using the token management section 220 described later, the transmitting and receiving section 100 outputs the packet.

The used queue information input section 102 receives queue information for identifying unused queues. The used queue information input section 102 includes, for example, a keyboard, a mouse and a microphone, and receives the input of queue information from the user of the packet transmission device. In addition, the used queue information input section 102 transmits queue information for identifying the unused queues to an unused queue management section 231 described later.

The token control circuit section 200 includes a storage section for storing programs for regulating the procedure of token control processing and the like and required data, and these are used to carry out various token control processing. The token control circuit section 200 includes a token storage memory 201, an access management section 210, a token management section 220 and an addition target control section 230 as the sections particularly closely related to the characteristics of this embodiment. The token storage memory 201 corresponds to a storage set forth in the claims.

The token storage memory 201 stores queue information and an accumulated token value so as to obtain correspondence therebetween. In this embodiment, a method is explained in which an addition token value in addition to the queue information and the accumulated token value is stored in the token storage memory 201 so as to obtain correspondence to them. Furthermore, for example, the token storage memory 201 stores the addition token value under the assumption that the token addition cycle is set at 100 μs (in the case that the token addition cycle is 100 μs) by the user of the packet transmission device.

However, it is not essential that the token storage memory 201 stores the addition token value. The token value addition processing section 222 described later should only be able to grasp the token value to be added at one time (or the output rate). For example, the information that is used to identify the token value to be added at one time to each queue by the token value addition processing section 222 described later may be stored in an internal storage section provided for the token value addition processing section 222. Furthermore, for example, it may be possible that the token storage memory 201 stores the output rate for each queue, and that the disclosed packet transmission device calculates the addition token value for each queue from the output rate stored in the token storage memory 201 and carries out the processing for adding the token value.

For example, the token storage memory 201 stores an addition token value and an accumulated token value so as to obtain correspondence to each of queue information as illustrated in FIG. 5. As an example, the token storage memory 201 stores an addition token value “12500 bytes” and an accumulated token value “300 bytes” so as to obtain correspondence to queue information #0. In addition, the token storage memory 201 stores an addition token value “12500 bytes” and an accumulated token value “100 bytes” so as to obtain correspondence to queue information #1.

A packet transmission device includes 1024 queues in the token storage memory 201 illustrated in FIG. 5. However, a packet transmission device may have any number of queues. For example, the packet transmission device include 24 queues. In that case, the token storage memory 201 stores the queue information and the accumulated token value so as to obtain correspondence therebetween in each of the 24 queues.

The access management section 210 reads information from the token storage memory 201 and writes information to the token storage memory 201 according to the instructions from the token management section 220 described later. The access management section 210 reads an addition token value and transmits the read addition token value to the token management section 220 described later according to the instructions of the token management section 220 described later. Furthermore, the access management section 210 reads an accumulated token value and transmits the read accumulated token value to the token management section 220 (the token value addition processing section 222 and the token value subtraction processing section 223 described later) according to the instructions of the token management section 220 described later.

Moreover, the access management section 210 adds (addition) the addition token value to the accumulated token value and transmits the added accumulated token value to the token value addition processing section 222 described later according to the instructions of the token value addition processing section 222 described later. Besides, the access management section 210 subtracts the packet length output from the queue 101 corresponding thereto from the accumulated token value and transmits the subtracted accumulated token value to the token value subtraction processing section 223 described later according to the instructions of the token value subtraction processing section 223 described later.

The access management section 210 performs access arbitration for the access according to the instructions from the token value addition processing section 222 described later and the access according to the instructions from the token value subtraction processing section 223 described later. For example, the access management section 210 performs processing to avoid the access from each component of the above-mentioned token management section 220 to the token storage memory 201 from causing a collision in the token storage memory 201 (for example, information is read from the same location simultaneously).

The token management section 220 is a control section for performing token control processing and includes the token value addition processing section 222 and the token value subtraction processing section 223 as sections particularly closely related to the characteristics of this embodiment. The token value addition processing section 222 includes an addition target information storage section 221 therein. Furthermore, the token value addition processing section 222 corresponds to “an adder” set forth in the claims.

In the token management section 220, the token value addition processing section 222 and the token value subtraction processing section 223 illustrated in the figure and described later separately perform token control processing to control packet output. When the packet stored in a queue 101 is output from the transmitting and receiving section 100, the token management section 220 issues, to the access management section 210, an instruction for reading, from the token storage memory 201, the accumulated token value corresponding to the queue 101, from which the packet is output, and captures the accumulated token value transmitted from the access management section 210. Furthermore, the token management section 220 permits the output of the packet from the queue 101 in the case that the captured accumulated token value is larger than the packet length of the packet stored in the queue. Moreover, the token management section 220 does not permit the output of the packet from the queue 101 in the case that the captured accumulated token value is smaller than the packet length of the packet stored in the queue.

The addition target information storage section 221 stores queue information for identifying the queues 101 selected using the addition target management section 233 described later. For example, as illustrated in FIG. 6, the addition target information storage section 221 stores “addition target queues” serving as queue information for indicating queues 101 to which a token value is added. When this is explained more specifically using the example illustrated in FIG. 6, the addition target information storage section 221 stores queue information #0, queue information #1, queue information #4, queue information #7, etc. in the case of the example illustrated in FIG. 6.

The addition target information storage section 221 stores an addition ratio serving as information (information that is used when a token value to be added actually is calculated) calculated using an addition ratio calculation section 234 described later. For example, as illustrated in FIG. 6, the addition target information storage section 221 stores the ratio occupied by the queues 101 selected using the addition target management section 233 described later from among the plural queues 101 provided for the packet transmission device as the addition ratio calculated using the addition ratio calculation section 234 described later. When this is explained more specifically using the example illustrated in FIG. 6, the addition target information storage section 221 stores “N” as the addition ratio.

The ratio itself occupied by the number of the queues 101 selected using the addition target management section 233 described later in the number of all the queues may also be used as the addition ratio “N” in the disclosed packet transmission device.

Furthermore, a preset value may also be used as the addition ratio “N” in the disclosed packet transmission device. For example, either one of 1/2, 1/4, 1/8, 1/16, 1/1024 may also be used in the disclosed packet transmission device. Hence, for example, the value to be used as the addition ratio may be limited to a certain value. As a result, the processing load at the time when the addition ratio is calculated using the addition ratio calculation section 234 described later is reduced, and the circuit that is used for the addition ratio calculation processing may be simplified.

Moreover, for example, in the case that a value that does not require relatively large-scale calculation processing (for example, the scale of the calculation processing in the case that a value such as 1/2, 1/4, 1/8 or the like is used becomes smaller than that in the case that a value such as 1/13, 1/31 or the like is used) is used as a value to be used as the addition ratio, the processing load at the time when the token value to be added actually is calculated using the token value addition processing section 222 described later may be reduced, and the circuit that is used for the addition token value calculation processing may be simplified.

When adding a given token value to respective plural queues 101, the token value addition processing section 222 adds the given token value to only the accumulated token value stored in the token storage memory 201 so as to correspond to the queue information for identifying the queues 101 selected using the addition target management section 233 described later. In other words, the token value addition processing section 222 adds the token value to only the queues 101 selected using the addition target management section 233 described later.

The token value addition processing section 222 issues, to the access management section 210, an instruction for adding the token value to only the queues 101 selected using the addition target management section 233 described later and corresponding to the queue information stored as an “addition target queues” in the addition target information storage section 221, and the access management section 210 adds the token value.

Furthermore, the token value addition processing section 222 issues, to the access management section 210, an instruction for adding the token value corresponding to the addition ratio calculated using the addition ratio calculation section 234 described later among the given token values to the queues 101 selected using the addition target management section 233 described later. The token value addition processing section 222 reads the “addition ratio” calculated using the addition ratio calculation section 234 described later and stored in the addition target information storage section 221. The token value addition processing section 222 issues, to the access management section 210, an instruction for adding the value obtained by multiplying the read “addition ratio” by the addition token value to the queues 101.

For example, when this is explained using the example illustrated in FIG. 6, in the case that queue #0, queue #1, queue #4 and queue #7 are selected using the addition target management section 233 described later, the token value addition processing section 222 adds the given token value to only queue #0, queue #1, queue #4 and queue #7 as illustrated in FIG. 7 (performs token control).

For example, when the token value addition processing section 222 selects one queue 101 from among the “addition target queues” stored in the addition target information storage section 221 (for example, when queue #0 is selected), the token value addition processing section 222 issues, to the access management section 210, an instruction for reading the addition token value corresponding to the queue information for identifying the queue 101 from the token storage memory 201, and captures the addition token value transmitted from the access management section 210. For example, the token value addition processing section 222 captures “12500 bytes” as the addition token value (see FIG. 5).

For example, in the case that the addition ratio is “1/2” and that the addition token value corresponding to the queue 101 to which the token value is added is “12500 bytes”. When the token value addition processing section 222 captures “12500 bytes” as the addition token value corresponding to the queue information for identifying the queue 101 serving as an addition target, the token value addition processing section 222 calculates the token value to be added actually. For example, since the addition ratio is “1/2”, the token value addition processing section 222 calculates to obtain “6250 bytes” corresponding to “1/2” of “12500 bytes” (see FIG. 8).

Furthermore, the token value addition processing section 222 issues, to the access management section 210, an instruction for adding the token value to be added actually to the queue 101 serving as an addition target, captures the accumulated token value to which the token value is added and which is transmitted from the access management section 210 and then transmits the accumulated token value to an accumulated token value upper-limit queue management section 232 described later. Moreover, the token value addition processing section 222 performs similar processing for all the addition target queues 101 sequentially one by one.

This will be further explained. The token value addition processing section 222 performs the token value addition processing for only the queues 101 selected using the addition target management section 233 described later, and on the other hand does not perform the token value addition processing for the queues not selected using the addition target management section 233 described later.

For example, a case in which the packet transmission device includes eight queues (queue #0 to queue #7) is taken as an example and explained for the sake of convenience in explanation. The token value addition processing section 222 performs the token value addition processing for queue #0, queue #1, queue #4 and queue #7, and on the other hand does not perform the token value addition processing for queue #2, queue #3, queue #5 and queue #6, that is, skips the processing.

In other words, in the disclosed packet transmission device, the token value addition processing section 222 carries out sequential processing, that is, reads the addition token value via the access management section 210 and adds the token value to only the queues 101 selected using the addition target management section 233 described later, captures the accumulated token values and transmits, to the accumulated token value upper-limit queue management section 232 described later, the accumulated token values and the queue information for identifying the queues 101 to which the token value is added.

In other words, in the disclosed packet transmission device, the token value addition processing section 222 does not carry out even the sequential processing for adding 0 as an addition token value to the queues 101 not selected using the addition target management section 233 described later. For example, the token value addition processing section 222 does not select the unselected queues 101 as the queues 101 subjected to the addition processing and does not carry out the processing for adding 0 as an addition token value.

The meaning of adding only the token value corresponding to the addition ratio will herein be described below. As described above, since the token value addition processing section 222 carries out the token value addition processing for only the queues 101 selected using the addition target management section 233 described later, the token addition cycle becomes short in comparison with the method in which the token value is added to all the queues 101.

Hence, if the token value is added to the respective queues 101 using the addition token value corresponding to the token addition cycle in the case that the token value is added to all the queues 101 (or using the addition token value corresponding to the token addition cycle before change in the case that the token addition cycle has been changed), the output rate of packets cannot be controlled constant.

For example, in the case that the token addition cycle becomes short, if the token value addition processing section 222 adds the addition token value having been set before the token addition cycle becomes short, more token values are added to the respective queues 101 than those before the token addition cycle becomes short, and the burst length is increased, whereby the packet transmission device cannot smooth the output rate. Furthermore, for example, in the case that the token addition cycle increases, if the token value addition processing section 222 adds the addition token value having been set before the token addition cycle increases, less token values are added to the respective queues 101 than those before the token addition cycle increases, whereby the packet transmission device cannot smooth the output rate.

Hence, in the disclosed packet transmission device, in the case that the token addition cycle is changed, the addition ratio calculation section 234 described later calculates the ratio by which the addition token value is changed, and the token value addition processing section 222 adds only the value corresponding to the addition ratio among the addition token values, whereby the output rate of packets may be controlled constant.

In the case that a packet stored in a queue 101 is output from the transmitting and receiving section 100 (for example, when the output of a packet is transmitted from the transmitting and receiving section 100), the token value subtraction processing section 223 subtracts the packet length of the output packet from the accumulated token value of the queues 101 from which the packet was output. The token value subtraction processing section 223 issues, to the access management section 210, an instruction for subtracting the packet length of the output packet from the accumulated token value, and the access management section 210 subtracts the token value from the accumulated token value.

For example, when this is explained more specifically using a case in which the accumulated token value corresponding to the information of the queue 101 from which a packet is output is “300 bytes” and the packet length of the output packet is “200 bytes”, the token value subtraction processing section 223 issues, to the access management section 210, an instruction for subtracting the packet length “200 bytes” from the accumulated token value “300 bytes”, and the access management section 210 sets the accumulated token value to “100 bytes”.

Furthermore, the token value subtraction processing section 223 captures the subtracted accumulated token value transmitted from the access management section 210, and transmits the subtracted accumulated token value and the queue information for identifying the queues 101 from which the token value was subtracted to the accumulated token value upper-limit queue management section 232 which will be described later.

The addition target control section 230 is a control section for carrying out the processing for the queues 101 serving as addition targets and includes the unused queue management section 231, the accumulated token value upper-limit queue management section 232, the addition target management section 233 and the addition ratio calculation section 234 as the sections particularly closely related to the characteristics of this embodiment. The unused queue management section 231 and the accumulated token value upper-limit queue management section 232 correspond to the a capturing unit set forth in the claims. Furthermore, the addition target management section 233 corresponds to the a selector set forth in the claims. Moreover, the addition ratio calculation section 234 corresponds to the ratio a calculator set forth in the claims.

The unused queue management section 231 captures the queue information for identifying the queues 101 not used in the packet transmission device. For example, the unused queue management section 231 captures the queue information for identifying unused queues transmitted from the used queue information input section 102. Furthermore, the unused queue management section 231 transmits the transmitted and captured queue information for identifying unused queues to the addition target management section 233 described later.

Whether the queues are unused or used is determined, for example, depending on the setting by the user of the packet transmission device, and the unused queue management section 231 captures the transmitted setting (the setting for setting queues as unused queues, the setting for setting queues as used queues, etc.) set by the user of the packet transmission device and transmits the setting to the addition target management section 233 described later.

The accumulated token value upper-limit queue management section 232 captures the queue information for identifying the queues 101 in which the accumulated token values exceed the given upper limit value. For example, each time the token management section 220 gains access to the token storage memory 201, the queue information is transmitted from the token management section 220, and the accumulated token value upper-limit queue management section 232 captures the queue information for identifying the queue 101 in which the accumulated token value exceeds the given upper limit value, and also captures the queue information for identifying the queue 101 in which the accumulated token value exceeded the given upper limit value but became lower than the given upper limit value. Furthermore, the accumulated token value upper-limit queue management section 232 transmits the captured queue information to the addition target management section 233 described later.

For example, each time the token value addition processing section 222 adds the token value and the accumulated token value to which the token value is added is transmitted from the token value addition processing section 222, the accumulated token value upper-limit queue management section 232 judges whether the transmitted accumulated token value exceeds the given upper limit having been set beforehand and captures the queue information for identifying the queues 101 to which the token value is added in the case that the accumulated token value exceeds the given upper limit. In addition, the captured queue information is transmitted to the addition target management section 233 described later.

When the accumulated token value is subtracted using the token value subtraction processing section 223, the accumulated token value upper-limit queue management section 232 judges that the queue from which the accumulated token value is subtracted is not the queue 101 in which the accumulated token value exceeds the given upper limit value. Moreover, in the case that the queue information for identifying the queue 101 from which the accumulated token value was subtracted has been transmitted as the queue information for identifying the queue in which the accumulated token value reaches the upper limit value to the addition target management section 233 described later, the accumulated token value upper-limit queue management section 232 transmits information to the effect that the queue 101 has not already been the queue 101 in which the accumulated token value reaches the upper limit value to the addition target management section 233 described later.

When the queue information is transmitted from the unused queue management section 231 or the accumulated token value upper-limit queue management section 232, the addition target management section 233 selects queues (for example, the queue information for identifying the queues) other than the queues identified by the captured queue information from among the plural queues provided for the packet transmission device.

For example, when queue information is transmitted from the unused queue management section 231 or the accumulated token value upper-limit queue management section 232 and there occurs changes in the addition target queues 101, the addition target management section 233 selects all the queue information for identifying unused queues 101 and queues other than the queues 101 in which the accumulated token values have reached the upper limit value from among the queue information for identifying the plural queues provided for the packet transmission device using the queue information transmitted from the unused queue management section 231 or the accumulated token value upper-limit queue management section 232. Furthermore, the addition target management section 233 stores the selected queue information in the addition target information storage section 221.

This is explained more specifically by taking, as an example, a case in which #2, #3, #5 and #6 are captured as the queue information for identifying the queues 101 in which the accumulated token values have reached the upper limit value by the accumulated token value upper-limit queue management section 232. The addition target management section 233 selects, for example, #0, #1, #4 and #7, as the queue information other than #2, #3, #5 and #6. Furthermore, the addition target management section 233 stores the selected #0, #1, #4 and #7 in the “addition target queues” of the addition target information storage section 221.

Furthermore, the addition target management section 233 transmits the number of pieces of the captured queue information to the addition ratio calculation section 234 described later and stores the addition ratio transmitted from the addition ratio calculation section 234 described later in the addition target information storage section 221.

For example, in the case that the selected queues are #0, #1, #4 and #7, the addition target management section 233 transmits information indicating that the number of the selected queues is four to the addition ratio calculation section 234 described later. Furthermore, in the case that the addition ratio N is transmitted from the addition ratio calculation section 234 described later, the addition target management section 233 stores the addition ratio N in the addition target information storage section 221.

When the queues 101 are selected and the number of the selected queues 101 is transmitted using the addition target management section 233, the addition ratio calculation section 234 calculates the ratio (addition ratio) occupied by the queues selected from among the plural queues. The addition ratio calculation section 234 is herein described using FIG. 8. Furthermore, the addition ratio calculation section 234 transmits the calculated addition ratio to the addition target management section 233.

FIG. 8 illustrates the relationship among “the number of queues required for token value addition control” indicating the number of queues to which the token is added, “token addition cycle”, “addition token value” and “addition ratio”. For example, in the case that the token value is added to all the 1024 queues provided for the packet transmission device, the number of queues required for token value addition control is 1024, the token addition cycle becomes 100 μs, the addition token value becomes 12500 bytes, and the addition ratio becomes 1.

For example, in the case that the number of queues selected using the addition target management section 233 is 512 as illustrated in FIG. 8, since the number of queues is reduced to 112, the addition ratio calculation section 234 calculates that the token addition cycle is 50 μs (1/2 of 100 μs), that the addition token value is 6250 bytes (1/2 of 12500 bytes) and that the addition ratio is 1/2. Furthermore, the addition ratio calculation section 234 transmits the addition ratio 1/2 to the addition ratio calculation section 234.

Although a method in which the addition ratio calculation section 234 calculates the token addition cycle, the addition token value and the addition ratio has been described herein, this embodiment is not limited to this method, but it may be possible that the addition ratio calculation section 234 calculates only the addition ratio, for example.

The packet transmission device can also be embodied by incorporating the functions of the used queue information input section 102, the token control circuit section 200, the token storage memory 201, the access management section 210, the token management section 220, the addition target information storage section 221, the token value addition processing section 222, the token value subtraction processing section 223, the addition target control section 230, the unused queue management section 231, the accumulated token value upper-limit queue management section 232, the addition target management section 233 and the addition ratio calculation section 234 described above in a known information processing apparatus, such as a personal computer, a work station, a portable telephone, a PHS terminal, a mobile communication terminal or a PDA.

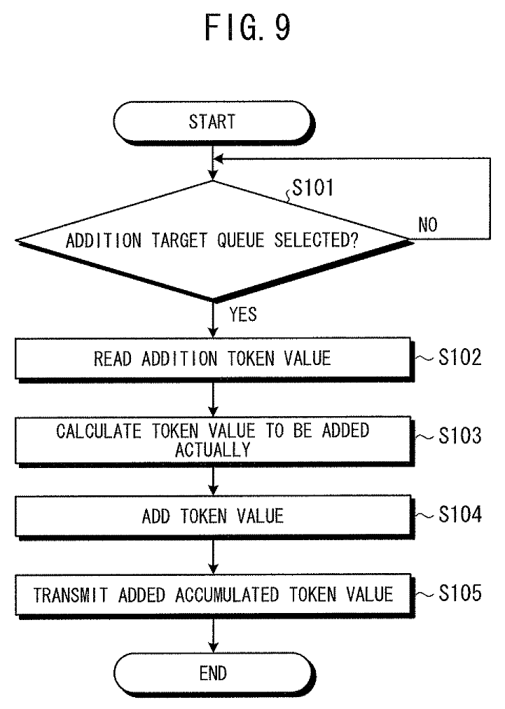

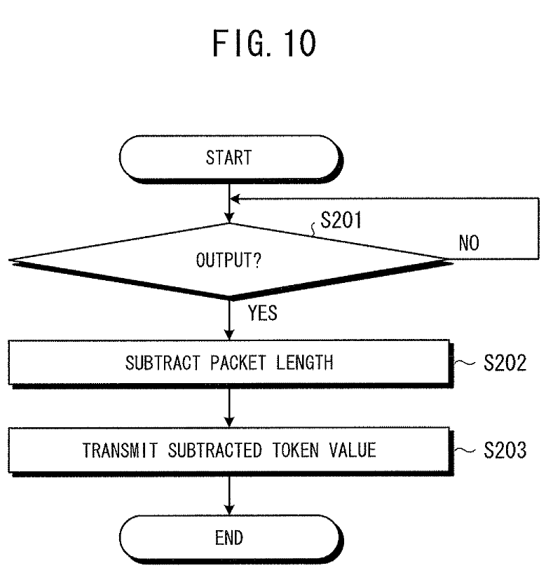

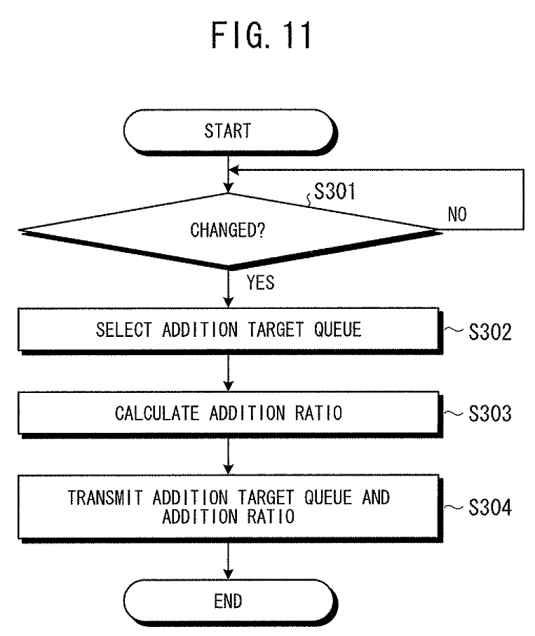

Next, processing by the packet transmission device will be described below using FIGS. 8 to 10. First, the flow of the processing for adding a token value is herein described, the flow of the processing for subtracting the token value is then described, and the flow of the processing of the addition target control section is described. FIG. 9 is a flowchart illustrating the flow of token value addition processing according to an exemplary embodiment. FIG. 10 is a flowchart illustrating the flow of token value subtraction processing according to an exemplary embodiment. FIG. 11 is a flowchart illustrating the flow of the processing of the addition target control section according to an exemplary embodiment.

As illustrated in FIG. 9, in the disclosed packet transmission device, when the token value addition processing section 222 selects one queue as an addition target (YES at operation S101), the token value addition processing section 222 reads the addition token value corresponding to the queue information for identifying the selected queue 101 (at operation S102). For example, upon selecting one of the addition target queues stored in the addition target information storage section 221, the token value addition processing section 222 issues, to the access management section 210, an instruction for reading the addition token value corresponding to the queue information for identifying the selected queue 101, and the access management section 210 captures the addition token value (for example, 12500 bytes) read from the token storage memory 201 (see FIG. 5).

Then, the token value addition processing section 222 calculates the token value to be added actually (at operation S103). For example, in the case that the addition ratio calculated using the addition ratio calculation section 234 and stored in the addition target information storage section 221 is 1/2, the token value addition processing section 222 calculates to obtain 6250 bytes corresponding to 1/2 of 12500 bytes (see FIG. 8).

Furthermore, the token value addition processing section 222 adds the token value (at operation S104). For example, the token value addition processing section 222 issues, to the access management section 210, an instruction for adding 6250 bytes, which is calculated as the token value to be added actually, to the queue 101 selected as an addition target. The access management section 210 adds the token value to the accumulated token value of the token storage memory 201.

Moreover, the token value addition processing section 222 transmits the accumulated token value to which the token value is added to the accumulated token value upper-limit queue management section 232 (at operation S105). For example, the token value addition processing section 222 captures the accumulated token value from the access management section 210 and transmits the captured accumulated token value to the accumulated token value upper-limit queue management section 232.

The token value addition processing section 222 carries out the processing from operation S101 to operation S105 described above to carry out the processing for sequentially adding the token value to all the addition target queues stored in the addition target information storage section 221. Furthermore, after carrying out the processing from operation S101 to operation S105 described above for all the addition target queues, the token value addition processing section 222 repeats the processing for sequentially adding the token value to all the addition target queues stored in the addition target information storage section 221, thereby continuing the processing for adding the token value.

As illustrated in FIG. 10, in the disclosed packet transmission device, when a packet is output (YES at operation S201) from a queue 101, the token value subtraction processing section 223 subtracts the packet length of the output packet from the accumulated token value of the queue 101 from which the packet is output (at operation S202). For example, in the case that the accumulated token value corresponding to the information of the queue 101 from which the packet is output is 300 bytes and that the packet length of the output packet is 200 bytes, the token value subtraction processing section 223 issues, to the access management section 210, an instruction for subtracting the packet length “200 bytes” from the accumulated token value “300 bytes”, and the access management section 210 sets the accumulated token value to 100 bytes.

Furthermore, the token value subtraction processing section 223 transmits the subtracted accumulated token value to the accumulated token value upper-limit queue management section 232 (at operation S203). For example, the token value subtraction processing section 223 captures the subtracted accumulated token value from the access management section 210 and transmits the captured accumulated token value to the accumulated token value upper-limit queue management section 232.

As illustrated in FIG. 11, in the disclosed addition target control section 230, when there is a change in a queue 101 (Yes at operation S301), the addition target management section 233 selects the queue 101 serving as an addition target from among 1024 queues 101 (at operation S302). In other words, when the queue information is captured using the unused queue management section 231 or the accumulated token value upper-limit queue management section 232 and then transmitted from the unused queue management section 231 or the accumulated token value upper-limit queue management section 232 to the addition target management section 233, the addition target management section 233 selects queues (for example, the queue information for identifying the queues) other than the queue identified by the captured queue information from among the plural queues provided for the packet transmission device.

Furthermore, the addition ratio calculation section 234 calculates an addition ratio (at operation S303). In other words, when the queue serving as an addition target is selected using the addition target management section 233, the addition ratio calculation section 234 calculates the ratio of the selected queue occupying in the plural queues and transmits the calculated addition ratio to the addition target management section 233.

Moreover, the addition target management section 233 transmits the selected queue information (the addition target queue) and the addition ratio transmitted from the addition ratio calculation section 234 to the token management section 220 (at operation S304). For example, the addition target management section 233 makes the addition target information storage section 221 store the selected queue information and the addition ratio.

As described above, according to an exemplary embodiment, the queue information for identifying a queue and the accumulated token value of the queue are stored so as to obtain correspondence therebetween, the queue information for identifying unused queues and the queue information for identifying the queues in which the accumulated token values exceed the given upper limit value are captured. After the capture of the queue information, and queues other than the queues identified by the captured queue information are selected from among the plural queues provided for the packet transmission device, and the given token value is added to the respective plural queues. At the time of the addition, the given token value is added to only the accumulated token values stored so as to correspond to the queue information for identifying the selected queues, whereby the output rate may be smoothed properly.

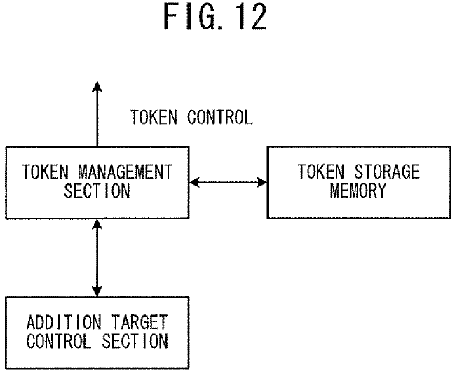

As illustrated in FIG. 12, in the disclosed packet transmission device, the token management section 220 includes the addition target control section 230 for selecting queues 101 serving as addition targets when the token addition processing is performed using the token storage memory 201. Hence, the processing for adding the token value is carried out for only the queues 101 selected using the addition target management section 233 described later, in the token value addition processing section 222 whereby the token addition cycle may be shortened.

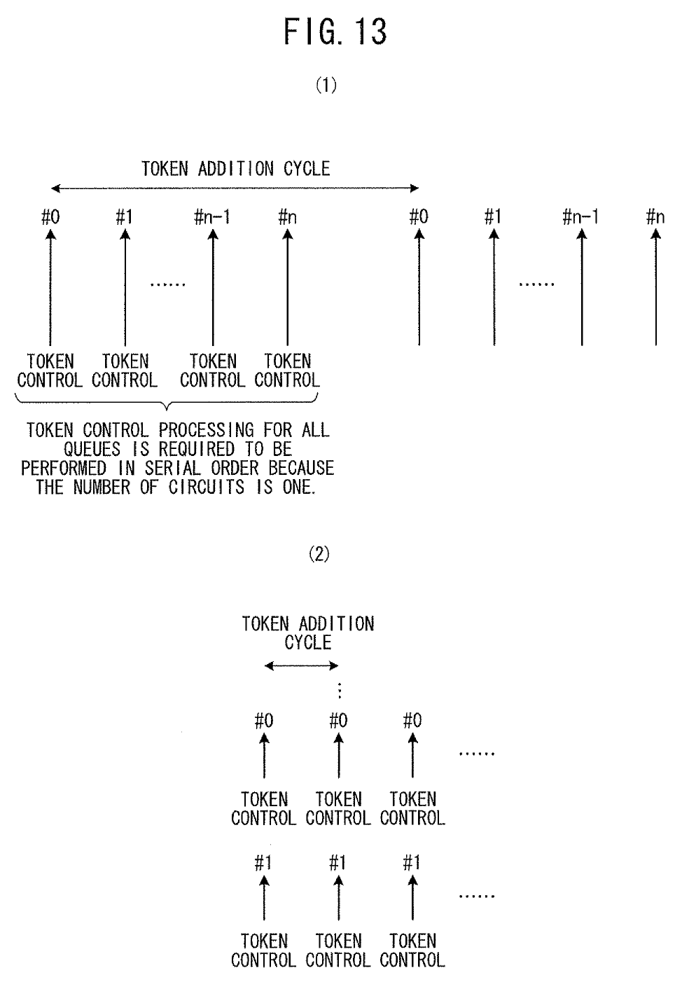

For example, as illustrated in FIG. 13(1), conventionally, a method in which the token value is added to all the queues under the charge of one circuit for carrying out the token control processing and the addition token value is increased as the number of queues is increased, the processing for adding 0 serving as an addition token value is also carried out for queues in which the accumulated token values have reached the given upper limit value.

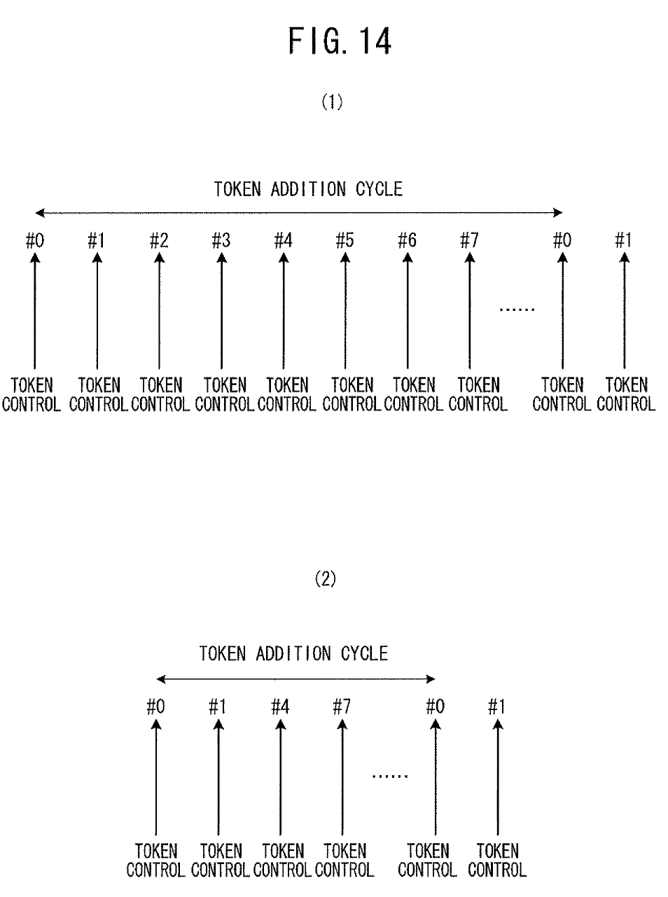

Unlike conventional methods, the method according to an exemplary embodiment carries out processing characterized in that in the case that no token value is added to queue #2, queue #3, queue #5 and queue #6, the addition processing for all the queues, illustrated in FIG. 14(1), is not performed (the processing for adding 0 serving as an addition token value is not performed even for queues to which no token value is added) and characterized in that the token value addition processing is skipped at queue #2, queue #3, queue #5 and queue #6 but is performed for only queue #0, queue #1, queue #4 and queue #7 as illustrated in FIG. 14(2),

Hence, unlike conventional methods in which the addition token value to be added at one time is increased, it is possible to smooth the output rate properly without increasing the addition token value to be added at one time.

Furthermore, unlike the conventional methods in which the token addition cycle is shortened using plural circuits as illustrated in FIG. 13 (2) as the number of queues is increased, the method according to an exemplary embodiment can smooth the output rate properly without using plural circuits (without increasing the size of the circuit).

Moreover, according to an exemplary embodiment, when queues 101 are selected, the ratio (addition ratio) of the selected queues 101 occupying in the plural queues 101 is calculated, and the token value that is included in the given token values and corresponds to the calculated addition ratio is added to the selected queues 101. As a result, the output rate of packets may be controlled constant.

For example, since the token value addition processing section 222 carries out the token value addition processing for only the queues 101 selected using the addition target management section 233, the token addition cycle becomes short in comparison with the method in which the token value is added to all the queues.

Hence, according to the conventional method remaining unchanged, if the token value is added to the respective queues 101 using the addition token value corresponding to the token addition cycle in the case that the token value is added to all the queues 101 (or using the addition token value corresponding to the token addition cycle before change in the case that the token addition cycle has been changed), the output rate of packets cannot be controlled constant.

For example, according to the conventional method remaining unchanged, in the case that the token addition cycle becomes short, if the token value addition processing section 222 adds the addition token value having been set before the token addition cycle becomes short, more token values are added to the respective queues 101 than those before the token addition cycle becomes short, and the burst length is increased, whereby the packet transmission device cannot smooth the output rate. Furthermore, for example, in the case that the token addition cycle increases, if the token value addition processing section 222 adds the addition token value having been set before the token addition cycle increases, less token values are added to the respective queues 101 than those before the token addition cycle increases, whereby the packet transmission device cannot smooth the output rate.

In an exemplary embodiment, in the case that the token addition cycle is changed, the addition ratio calculation section 234 calculates the ratio by which the addition token value is changed, and the token value addition processing section 222 adds only the value corresponding to the addition ratio among the addition token values, whereby the output rate of packets may be controlled constant.

In an exemplary embodiment a method for skipping processing for unused queues and the like and for changing the token value to be added when the token addition cycle is changed may be combined and carried out. It is also be possible that only the method for skipping processing for unused queues and the like is carried out.

The processing procedures, control procedures, specific names and information including various data and parameters given in the above-mentioned descriptions and figures (for example, FIGS. 3 to 10 and FIG. 15) may be modified as desired unless otherwise specified.

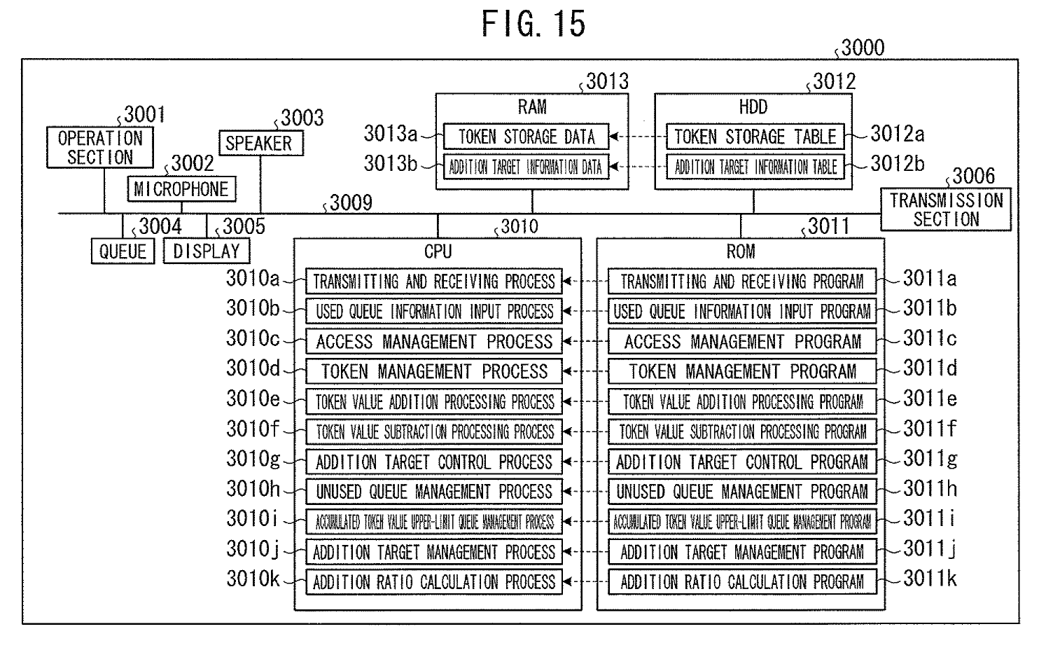

In an exemplary embodiment various types of processing may be achieved using hardware logic, but the exemplary embodiment is not limited to this. Such various types of processing may also be achieved by executing prepared programs using a computer. Hence, an example of a computer that executes packet transmission programs having functions similar to those of the packet transmission device described in the above-mentioned exemplary embodiment will be described below using FIG. 15. FIG. 15 illustrates the programs of the packet transmission device according to an exemplary embodiment.

As illustrated in FIG. 15, in a packet transmission device 3000 according to an exemplary embodiment, an operation section 3001, a microphone 3002, a speaker 3003, a queue 3004, a display 3005, a transmission section 3006, a CPU 3010, a ROM 3011, an HDD 3012 and a RAM 3013 are connected via a bus 3009 and the like.

In the ROM 3011, control programs can execute processes causing a computer to act as transmitting and receiving section 100, the used queue information input section 102, the access management section 210, the token management section 220, the token value addition processing section 222, the token value subtraction processing section 223, the addition target control section 230, the unused queue management section 231, the accumulated token value upper-limit queue management section 232, the addition target management section 233 and the addition ratio calculation section 234 described in the above-mentioned an exemplary embodiment, in other words, a transmitting and receiving program 3011a, a used queue information input program 3011b, an access management program 3011c, a token management program 3011d, a token value addition processing program 3011e, a token value subtraction processing program 3011f, an addition target control program 3011g, an unused queue management program 3011h, an accumulated token value upper-limit queue management program 3011i, an addition target management program 3011j and an addition ratio calculation program 3011k have been stored beforehand as illustrated in the figure. These programs 3011a to 3011k may be integrated or separated as necessary, just like the various components of the packet transmission device illustrated in FIG. 3.

The CPU 3010 reads these programs 3011a to 3011k from the ROM 3011 and executes them, whereby the programs 3011a to 3011k function as a transmitting and receiving process 3010a, an used queue information input process 3010b, an access management process 3010c, a token management process 3010d, a token value addition processing process 3010e, a token value subtraction processing process 3010f, an addition target control process 3010g, an unused queue management process 3010h, an accumulated token value upper-limit queue management process 3010i, an addition target management process 3010j and an addition ratio calculation process 3010k as illustrated in FIG. 15. The processes 3010a to 3010k respectively correspond to the transmitting and receiving section 100, the used queue information input section 102, the access management section 210, the token management section 220, the token value addition processing section 222, the token value subtraction processing section 223, the addition target control section 230, the unused queue management section 231, the accumulated token value upper-limit queue management section 232, the addition target management section 233 and the addition ratio calculation section 234 illustrated in FIG. 3.

Furthermore, the HDD 3012 includes a token storage table 3012a and an addition target information table 3012b. The tables 3012a and 3012b correspond to the token storage memory 201 and the addition target information storage section 221 illustrated in FIG. 3, respectively.

Moreover, the CPU 3010 reads the token storage table 3012a and the addition target information table 3012b, stores them in the RAM 3013, and executes packet transmission programs using the token storage data 3013a and the addition target information data 3013b stored in the RAM 3013.

The packet transmission device may be embodied by executing programs prepared in advance using a computer, such as a personal computer or a work station. These programs may be distributed via a network, such as the Internet. Furthermore, these programs may be recorded on computer-readable recording media, such as hard disks, flexible disks (FDs), CD-ROMs, MOs and DVDs, and may be read from such recording media and executed using a computer.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A packet transmission device comprising:
a plurality of queues for storing packets to be transmitted,
a token storage section for storing queue information for identifying the queue and an accumulated token value in which token values assigned to the queue are accumulated, so as to obtain correspondence therebetween,
a capture section for identifying one or both of an unused queue and a queue in which the accumulated token value exceeds a given upper limit value and capturing the queue information of the queue,
a selection section for selecting the queue information of the unidentified queue on the basis of the queue information captured using the capture section,
an addition section for adding the accumulated token value of the token storage section on the basis of the queue information selected using the selection section,
a token control section for comparing the packet length of the packet stored in the queue with the accumulated token value corresponding to the queue and judging whether the output of the packet is possible, and
a packet output control section for outputting the packet from the queue and subtracting the packet length from the accumulated token value in the case that the token control section has judged that the packet output is possible.

2. The packet transmission device according to claim 1, further comprising:
a ratio calculating section for calculating the ratio occupied by the queues selected from among the plurality of queues when the queues are selected using the selecting section, wherein
the addition section adds a token value corresponding to the ratio calculated using the ratio calculating section among the given token values to the queues selected using the selecting section.

3. A packet transmission method for a packet transmission device comprising:
a plurality of queues for storing packets to be transmitted, and
a token storage section for storing queue information for identifying the queue and an accumulated token value in which token values assigned to the queue are accumulated, so as to obtain correspondence therebetween, the method comprising:
the capturing operation of identifying one or both of an unused queue and a queue in which the accumulated token value exceeds a given upper limit value and capturing the queue information of the queue,
the selecting operation of selecting the queue information of the unidentified queue on the basis of the queue information captured in the capturing operation,
the adding operation of adding the accumulated token value of the token storage section on the basis of the queue information selected in the selecting operation,
the token controlling operation of comparing the packet length of the packet stored in the queue with the accumulated token value corresponding to the queue and judging whether the output of the packet is possible, and
the packet output control operation of outputting the packet from the queue and subtracting the packet length from the accumulated token value in the case that it has been judged that the packet output is possible in the token controlling operation.

4. A recording medium recording a packet transmission program executed in a packet transmission device comprising:
a plurality of queues for storing packets to be transmitted,
a token storage section for storing queue information for identifying the queue and an accumulated token value in which token values assigned to the queue are accumulated, so as to obtain correspondence therebetween, and
a calculation section for executing the program, the packet transmission program comprising:
the capturing operation of identifying one or both of an unused queue and a queue in which the accumulated token value exceeds a given upper limit value and capturing the queue information of the queue,
the selecting operation of selecting the queue information of the unidentified queue on the basis of the queue information captured in the capturing operation,
the adding operation of adding the accumulated token value of the token storage section on the basis of the queue information selected in the selecting operation,
the token controlling operation of comparing the packet length of the packet stored in the queue with the accumulated token value corresponding to the queue and judging whether the output of the packet is possible, and
the packet output control operation of outputting the packet from the queue and subtracting the packet length from the accumulated token value in the case that it has been judged that the packet output is possible in the token controlling operation.
